(19) United States
(12) Patent Application Publication
(10) Pub. No.: US 2015/0358336 A1
(43) Pub. Date: Dec. 10, 2015

(54) METHOD FOR DETECTING FRAUD IN AN IMS NETWORK

(71) Applicant: ORANGE, Paris (FR)

(72) Inventors: Jean-Claude Le Rouzic, Trebeurden (FR); José Doree, Lannion (FR)

(21) Appl. No.: 14/763,461

(22) PCT Filed: Jan. 24, 2014
(86) PCT No.: PCT/FR2014/050142

§ 371 Date: Jul. 24, 2015

(30) Foreign Application Priority Data
Jan. 28, 2013 (FR) 1350689

(51) Int. Cl. H04L 29/06

(52) U.S. Cl. CPC H04L 63/126; H04L 63/20

(57) ABSTRACT

A fraud detection method which may be performed by an HSS server in an IMS network is provided. It may comprise receiving a message from an I-CSCF or an S-CSCF entity, the message mentioning a public identity and a private identity and verifying the validity and the consistency of said public and private identities, the message also mentioning at least one address of a user in the IMS network. If invalidity or inconsistency is found, the method may include storing information to the effect that a fraud has been detected for a set comprising the public identity, the private identity and the at least one address.

### BACKGROUND OF THE INVENTION

The invention lies in the field of detecting fraud in an internet protocol (IP) multimedia subsystem (IMS) network.

Telephone operators have begun to migrate their telephone networks to voice over IP (VoIP) networks. The convergence between fixed and mobile networks is made available by means of architectures specified by the Third Generation Partnership Project (3GPP) standards organization, using IMS solutions.

Unlike switched telephone networks, voice over IP networks are exposed to the world of the Internet and to the imagination of malicious parties (or pirates) in terms of attacks and attempts at usurping identities, of the kind that are specific to IP networks.

In order to limit the consequences of such attacks, certain operators have put into place mechanisms for locking user accounts when a threshold for unsuccessful attempts at connecting with the network is exceeded, which threshold can be set by the operator.

That mechanism is not satisfactory since it enables pirates to deliberately lock out certain accounts by systematically and successively making attempts on all of the number ranges allocated to a particular operator, and as a result such mechanisms are not used in practice.

Given the very large amount of traffic on IMS networks, it is also very complicated to detect attacks as they occur, such that protection measures are usually implemented when a subscriber informs the operator of an abnormal increase in that subscriber's consumption.

One of the objects of the invention is to propose a solution to those problems.

### OBJECT AND SUMMARY OF THE INVENTION

Thus, and in general manner, the invention proposes a centralized solution for detecting, on the fly, attempts at fraud in an IMS network, and in particular attempts at usurping identity.

More precisely, the invention relates to a method of detecting fraud that is performed by a home subscriber server (HSS) in an IMS network. The method comprises:
a step of receiving a message from an interrogating call state control function (I-CSCF) or a serving call state control function (S-CSCF) entity, said message mentioning a public identity, a private identity, and at least one address of a user in the IMS network;
a step of verifying the validity and the consistency of the public and private identities; and
if the verification step finds invalidity or inconsistency, a step of storing information whereby a fraud has been detected for a set comprising the public identity, the private identity, and the address.

In a particular implementation, the fraud detection method of the invention further comprises:
a step of using said message to detect inconsistency in an authentication scheme or to detect an authentication failure; and
in the event of making such a detection, a step of storing information to the effect that a fraud has been detected for a set comprising at least said public identity, said private identity, and said at least one address.

Correspondingly, the invention provides an HSS server comprising:
means for receiving a message coming from an I-CSCF or an S-CSCF entity in an IMS network, the message mentioning a public identity, a private identity, and at least one address of a user in the IMS network;
means for verifying the validity and the consistency of said public and private identities; and
means for acting, if invalidity or inconsistency is found, to store information whereby a fraud has been detected for a set comprising the public identity, the private identity, and the address.

In a particular embodiment, the HSS server of the invention further comprises:
means for detecting, from the message, inconsistency in an authentication scheme or for detecting an authentication failure; and
in the event of making such a detection, memory means for storing information whereby a fraud has been detected for a set including at least said public identity, said private identity, and said at least one address.

As described in detail below, the invention applies in particular to user authorization request UAR, multimedia authorization request MAR, and server assignment request SAR messages.

Thus, and in general manner, the invention proposes distinguishing a malicious user (or pirate) from a legitimate user on the basis of the user's address in the IMS network.

In most advantageous manner, the fraud detection method of the invention does not disturb the services supplied to the possessor of the account.

Furthermore, frauds are detected on the fly, such that protection measures can be taken more quickly, i.e. as from the first fraudulent access.

In a preferred implementation of the fraud detection method of the invention, the message of the invention includes a binary flag indicating whether the user is or is not accessing the IMS network via a network address translation (NAT) entity.

Under such circumstances, the address included in the message is constituted by:
a pair (public IP address, public port) when said access is not made via an NAT; or
a quadruplet (public IP address, public port, private IP address, private port) when said access is made via an NAT.

The invention thus makes it possible to detect attacks from pirates whether they access the IMS network directly or from behind an NAT. The subsequent processing of attacks by the operator may possibly take this parameter into consideration.

In a particular implementation, in the event of the public and private identities being found invalid or inconsistent, the fraud detection method of the invention includes a step of incrementing a first fault counter associated with the set including the public identity, the private identity, and the address.

In a particular implementation, in the event of detecting inconsistency in an authentication scheme or detecting an authentication failure, the fraud detection method of the invention further includes a step of incrementing a second fault counter associated with the set including the public identity, the private identity, and the address.

In a particular implementation, the fraud detection method of the invention includes a step of updating a global fault counter associated with the public identity, the global fault counter summing all of the first and second counts associated with a set including the public identity.

Each of the counters may be associated with one or more predetermined thresholds, with specific fraud management actions being implemented when criteria based on those counters and those thresholds are satisfied.

For example, when one of the counters exceeds a first predetermined threshold, the HSS server of the invention sends a message to the I-CSCF entity, which message includes the identity of a fraud collector S-CSCF entity.

This particular aspect of the invention enables registration requests sent by pirates to be redirected to a “honeypot” for the purpose of analyzing, understanding, and listing the procedures used by pirates for making fraudulent use of user accounts.

It should be recalled that “honeypots” are deliberately vulnerable entities set up for the purpose of trapping pirates.

Unfortunately, the “honeypot” solutions presently in use by certain operators are not very effective since the probability of a pirate being caught out by such solutions is very low. In the present state of the art, a pirate attacks such a honeypot purely by chance, e.g. when using an IP scan method for determining target addresses in systematic or random manner.

This particular implementation of the invention in which the traffic from the pirate is redirected, unknown to the pirate, to a honeypot greatly improves presently-known techniques.

In a second example, which does not exclude the first example described above, when one of the counters exceeds a second predetermined threshold, the HSS server of the invention sends an error code to the I-CSCF entity.

In a particular implementation, the various steps of the above-mentioned fraud detection method are determined by computer program instructions.

Consequently, the invention also provides a computer program on a data medium, the program being suitable for being performed in an HSS server, the program including instructions adapted to performing the steps of the fraud detection method as mentioned above.

Either of these programs may use any programming language, and may be in the form of source code, object code, or code intermediate between source code and object code, such as a partially compiled form, or in any other desirable form.

The invention also provides a computer readable data medium that may be non-removable, or partially or completely removable, and that includes instructions of a computer program as mentioned above.

The data medium may be any entity or device capable of storing the program. For example, the medium may include storage means, such as a read only memory (ROM), e.g. a compact disk (CD) ROM, or a microelectronic circuit ROM, or magnetic recording means such as a hard disk, or indeed a universal serial bus (USB) flash drive.

Furthermore, the data medium may be a transmissible medium such as an electrical or optical signal, suitable for being conveyed via an electrical or optical cable, by radio, or by other means. The program of the invention may in particular be downloaded from an Internet type network.

Alternatively, the data medium may be an integrated circuit in which the program is incorporated, the circuit being adapted to execute or to be used in the execution of the method in question.

### BRIEF DESCRIPTION OF THE DRAWINGS

Other characteristics and advantages of the present invention appear from the following description given with reference to the accompanying drawings, which show an embodiment having no limiting character. In the figures:

FIG. 1 shows an HSS server, an I-CSCF entity, and an S-CSCF entity in accordance with a particular embodiment of the invention in an IMS network;

FIGS. 2A, 2B, and 2C show respectively the hardware architectures of the HSS server, the I-CSCF entity, and the S-CSCF entity of FIG. 1;

FIG. 3 shows a message in accordance with the invention;

FIG. 4 is in the form of a flow chart showing the main steps of a method of detecting fraud in a particular implementation of the invention; and

FIGS. 5 and 6 are flow charts showing the main steps of two message sending methods in accordance with two particular implementations of the invention.

### DETAILED DESCRIPTION OF THE INVENTION

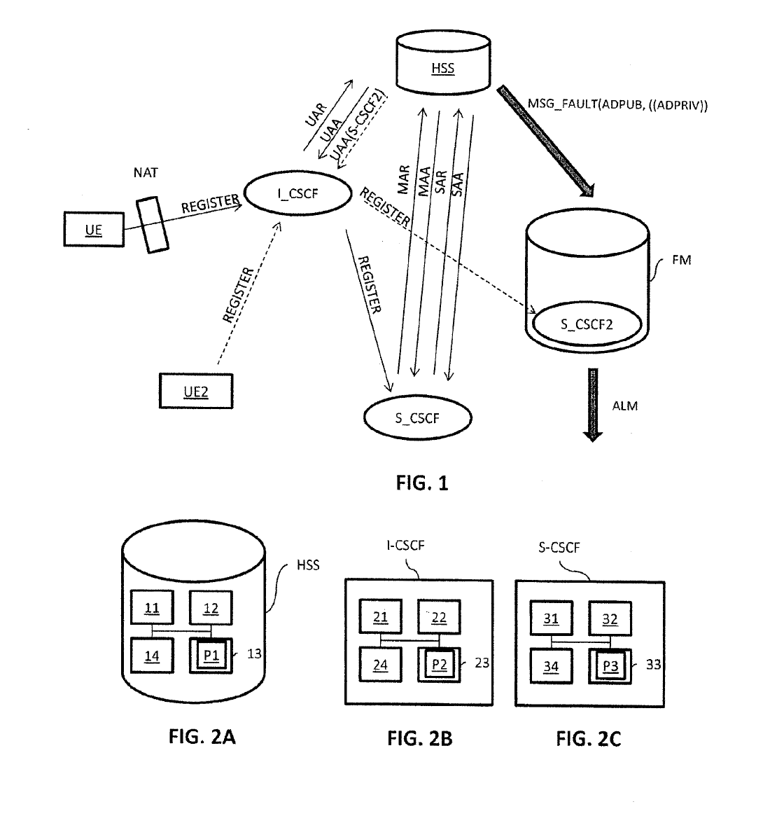

FIG. 1 shows a HSS server, an I-CSCF entity, and an S-CSCF entity in accordance with the invention in an IMS network. It also shows the various messages exchanged over the session initiation protocol SIP and Diameter interfaces when registering a subscriber UE (continuous lines) or a pirate UE2 (dashed lines) in the network. Only those messages that are necessary for understanding the invention are shown.

In this embodiment, the IMS network has a fraud manager FM incorporating an S-CSCF2 entity that is used as a “honeypot” as described below.

In this example, it is assumed that the subscriber UE accesses the IMS network behind network address translation equipment NAT, while the pirate UE2 accesses the IMS network directly, i.e. without passing via any equipment NAT.

FIGS. 2A, 2B, and 2C are diagrammatic figures showing the hardware architectures of the HSS server, of the I-CSCF entity, and of the S-CSCF entity.

In the presently-described embodiment, each of these pieces of equipment has the hardware architecture of a computer.

The HSS server has a processor 11, a random access memory (RAM) 12, a ROM 13, and communication means 14.

The ROM 13 includes a computer program P1 in accordance with the invention for executing a fraud detection method in accordance with the invention, and having main steps E10 to E60 that are described below with reference to FIG. 4.

The I-CSCF entity has a processor 21, a RAM 22, a ROM 23, and communication means 24.

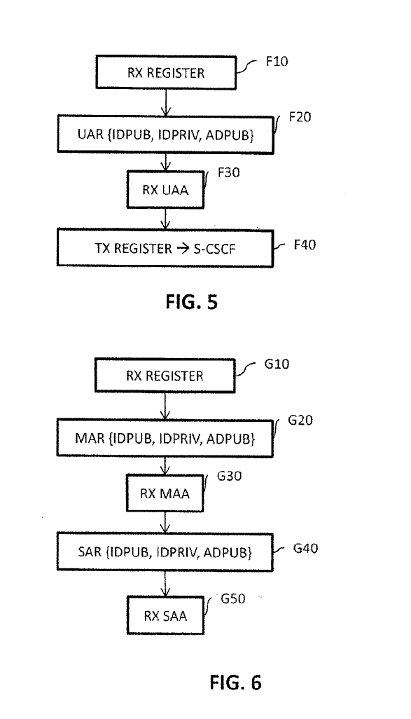

The ROM 23 contains a computer program P2 in accordance with the invention for executing a message sending method in accordance with the invention having main steps F10 to F40 that are described below with reference to FIG. 5.

The S-CSCF entity has a processor 31, a RAM 32, a ROM 33 and communication means 34.

The ROM 33 contains a computer program P3 in accordance with the invention for executing a message sending method in accordance with the invention and having main steps G10 to G50 that are described below with reference to FIG. 6.

With reference to FIG. 1, it is assumed that the I-CSCF entity receives a registration request REGISTER from the subscriber UE or from the pirate UE2 during a step F10. In known manner, this request includes a public identity IDPUB and a private identity IDPRIV of the subscriber UE or of the pirate UE2.

As in known manner, on receiving this registration request, the server I-CSCF interrogates the HSS server to find out whether the public and private identities IDPUB and IDPRIV are known to the HSS server and whether they are authorized to access the IMS network. To this end, the server I-CSCF sends a UAR message to the HSS server during a step F20. The HSS server receives this request UAR during a step E10.

As in the prior art, this UAR request includes the public and private identities IDPUB and IDPRIV contained in the registration request REGISTER.

In accordance with the invention, this UAR request also includes the public address ADPUB of the equipment sending the registration request REGISTER, possibly together with the private address ADPRIV of that equipment, should it be behind address translation equipment NAT.

In the presently-described embodiment, a public address ADPUB is constituted by a pair (IP address @IPPUB, port @PORTPUB); likewise a private address ADPRIV is constituted by a pair (IP address @IPRIV, port @PORTPRIV).

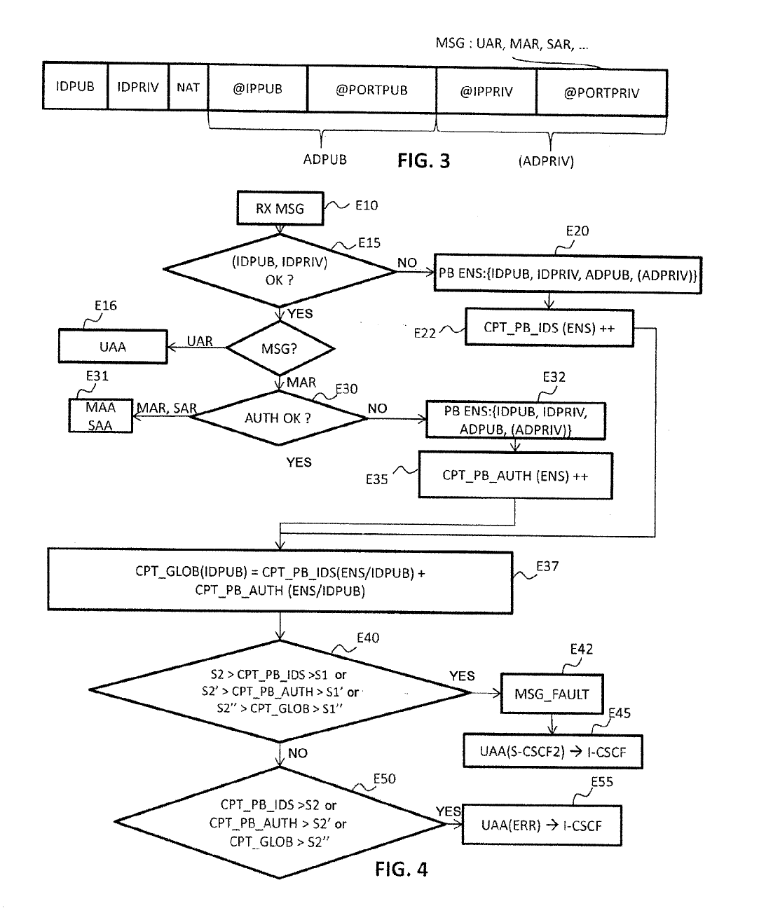

The UAR message thus complies with the message MSG shown in FIG. 3. It should be observed that the message MSG includes a binary flag NAT of value indicating whether the user is accessing or is not accessing the IMS network via an address translation NAT entity. If so, the private address ADPRIV is present in the message MSG.

During a step E15, the HSS server verifies the validity and the consistency of the public and private identities IDPUB and IDPRIV.

If verification is successful, the HSS server sends an acknowledge message UAA to the I-CSCF entity during a step E16, this acknowledge message being received by the I-CSCF entity during a step F30.

Thereafter, as in known manner, the I-CSCF entity selects an S-CSCF entity during a step F40 and forwards it the registration request received in step F10.

The S-CSCF entity receives this registration request REGISTER during a step G10.

During a step G20, the HSS sends an MAR request to the HSS server in order to obtain authentication information.

As in the prior art, this MAR request includes the public and private identities IDPUB and IDPRIV included in the registration request REGISTER.

In accordance with the invention, this MAR request also includes the public address ADPUB of the equipment that sent the registration request REGISTER, possibly together with the private address ADPRIV of that equipment, when it is behind address translation equipment NAT.

This MAR registration request is in compliance with the message MSG shown in FIG. 3.

This MAR registration request is received by the HSS server during another instance of the above-described step E10. Thus, on receiving this request, the HSS entity performs step E15 to verify the validity and the consistency of the public and private identities IDPUB and IDPRIV.

If this is successful, the HSS server returns an acknowledge message MAA to the S-CSCF entity during a step E31, this acknowledge message being received by the S-CSCF entity during a step G30.

If the authentication of the subscriber UE is correct, the S-CSCF entity acts during a step G40 to send an SAR request to the HSS in order to download the service profile of the subscriber.

As in the prior art, this SAR request includes the public and private identities IDPUB and IDPRIV included in the registration request REGISTER.

In accordance with the invention, this SAR request also includes the public address ADPUB of the equipment that sent the registration request REGISTER, possibly together with the private address ADPRIV of that equipment, when it is accessing from behind address translation equipment NAT.

The SAR request thus complies with the message MSG shown in FIG. 3.

This registration SAR request is received by the HSS server during another instance of above-described step E10. Thus, on receiving this request, the HSS entity performs the step E15 to verify the validity and the consistency of the public and private identities IDPUB and IDPRIV.

If this is successful, the HSS server returns an acknowledge message SAA to the S-CSCF entity during a new instance of the step E31, this acknowledge message being received by the S-CSCF entity during a step G50.

In other words, the entities I-CSCF and S-CSCF in accordance with the invention differ from those known in the prior art in that, during each of their exchanges over the Diameter interfaces, they send information ADPUB enabling the subscriber UE or the pirate UE2 to be identified by the corresponding IP transport address and its port (IP address and user data protocol (UDP) or transmission control protocol (TCP) port over which the registration is received), possibly together with private information ADPIV when access is performed from behind an NAT.

These addresses ADPUB and ADPRIV are accessible by the entities I-CSCF and S-CSCF, e.g. in the SIP header Via, in the Contact header, or in any other information element known to the person skilled in the art.

In the presently-described embodiment, this address information is supplied to the HSS server in a new Diameter attribute value pair (AVP) dedicated to this purpose or in the existing frame-IP address AVP with an extension if access is from behind an NAT.

With reference to FIG. 4, there follows an explanation of the processing of the messages received over the Diameter interface by the HSS server, in the event of the public or private identities IDPUB or IDPRIV being invalid or inconsistent (test E15 giving a negative result) and in the event of inconsistency with an authentication scheme or in the event of a failure of authentication (test E30 giving a negative result).

For either of these problems, information is stored (step E20 or E32) to the effect that a fraud has been detected for the triplet ENS {public identity IDPUB, private identity IDPRIV, public address ADPUB}, or when access is from behind an NAT, for the quadruplet ENS {public identity IDPUB, private identity IDPRIV, public address ADPUB, private address ADPRIV}.

In the presently-described implementation, three counters are used, namely:
a first counter CPT_PB_IDS associated with the triplet/quadruplet set ENS incremented during a step E22 when the HSS detects a problem of validity and consistency in the public or private identities IDPUB or IDPRIV (negative result from test E15);
a second counter CPT_PB_AUTH, associated with the triplet/quadruplet set ENS incremented during a step E35 when the HSS detects inconsistency in an authentication scheme or an authentication failure; and
a global fault counter CPT_GLOB associated with the public identity IDPUB, updated during a step E37 and summing said first and second counters CPT_PB_IDS and CPT_PB_AUTH associated with all the triplets/quadruplets ENS including this public identity IDPUB.

The first counter CPT_PB_IDS in particular is incremented (step E22) as soon as the following errors are observed by the HSS on receiving Diameter UAR, MAR, and SAR commands:
DIAMETER_ERROR_IDENTITIES_DONT_MATCH,
DIAMETER_AUTHORIZATION_REJECTED.

The second counter CPT_PB_AUTH is incremented in particular (step E35) as soon as the following errors or information is/are observed or received by the HSS in the Diameter MAR and SAR commands:
DIAMETER_ERROR_AUTH_SCHEME_NOT_SUPPORTED, or
AVP Server-Assignment type set to Authentication_failure, or indeed
AVP Server-Assignment type set to Authentication timeout.

The global fault counter CPT_GLOB, as updated in step 37, serves to detect an attack by address variation, in the event of the pirate changing only one element of the address, e.g. the port, since under such circumstances, the global counter will increase very quickly.

In the presently-described implementation, two thresholds are defined for each of the counters, and more precisely:
a first threshold S1 and a second threshold S2 for the first counter CPT_PB_IDS;
a first threshold S1′ and a second threshold S2′ for the second counter CPT_PB_AUTH; and
a first threshold S1″ and a second threshold S2″ for the global counter CPT_GLOB.

These counters may be used to perform specific actions when a fraud is detected. They are preferably re-initialized or destroyed if no fraud is detected over some predetermined duration.

In the presently-described implementation, when at least one of these counters CPT_PB_IDS, CPT_PB_AUTH, CPT_GLOB is greater than its first threshold S1, S1′, S1″, while all three counters are less than their second thresholds S2, S2′, S2″ (positive result from test E40), the HSS server acts during a step E42 to send a message MSG FAULT to the fraud manager FM, this message including the public address and possibly the private address of the pirate UE2. An alarm ALM may be returned to the operator so that the operator can analyze the pirate's strategy.

In this implementation, when this condition is true, the HSS server acts during a step E45 to send a message UAA to the I-CSCF entity, which message includes the identifier S-CSCF2 of a fraud collector S-CSCF entity.

The subsequent registration requests sent by the pirate UE2 presenting the characteristics of an attack will thus be rerouted to the fraud collector S-CSCF2 entity using the honeypot mechanism known to the person skilled in the art.

Supplying this S-CSCF name does not lead to procedures for releasing the S-CSCF assigned to the user UE, who continues to have service available even during an attack against that user's client account.

In the presently-described implementation, as soon as one of the counters CPT_PB_IDS, CPT_PB_AUTH, CPT_GLOB exceeds its second threshold S2, S2′, S2″, the above-described mechanism for redirection to the S-CSCF2 honeypot is interrupted so as to protect the honeypot itself. In contrast, the HSS server acts during a step E55 to send a message to the I-CSCF entity, which message includes an error code ERR, e.g. the Diameter return code DIAMETER-ERROR-DROP. On receiving this message, the server I-CSCF can decide to cease responding to messages from the pirate; since the pirate thus no longer obtains any information in response to the attack being made, the pirate might stop.

The thresholds S2, S2′, and S2″ are selected to be large enough to enable the S-CSCF2 honeypot to recover enough pertinent information about fraud.

Other counters (e.g. one per type of Diameter command) and/or other utilizations of these counters may be used without going beyond the ambit of the invention.

With reference to FIG. 2A:
the communication means 14 of the HSS server constitute the means for receiving the messages MSG, in particular the above-described UAR, MAR, and SAR messages, coming from the entities I-CSCF or S-CSCF in accordance with the invention;
the processor 11 of the HSS server is suitable on executing the instructions of the program P1 stored in the memory 13 for verifying the validity and the consistency of said public and private identities IDPUB and IDPRIV, and for detecting an authentication problem on the IMS network; and
the memory 13 of the HSS server constitutes storage means for storing information to the effect that a fraud has been detected for a set including at least a public identity IDPUB, a private identity IDPRIV, and at least one address ADPUB, ADPRIV.

Likewise, with reference to FIGS. 2B and 2C, the communication means 24 and 34 of the entities I-CSCF and S-CSCF constitute means for sending a message MSG to an HSS server in accordance with the invention.

In the above description, the information to the effect that a fraud has been detected is stored in a triplet or quadruplet set including the public identity IDPUB, the private identity and the address ADPUB, possibly together with ADPRIV when access is from behind an NAT.

In a variant, this information is stored not for a public identity IDPUB but for an Implicit Registration ID Set (IRS) including this public identity.

1. A fraud detection method performed by an HSS server in an IMS network, the method comprising:
receiving a message from an I-CSCF or an S-CSCF entity, said message mentioning a public identity, a private identity and at least one address of a user in the IMS network;
verifying the validity and the consistency of said public and private identities;
wherein if said verification process finds invalidity or inconsistency, the fraud detection method further includes:
storing information to the effect that a fraud has been detected for a set comprising said public identity, said private identity and said at least one address.

2. A fraud detection method according to claim 1, further comprising:
using said message to detect inconsistency in an authentication scheme or to detect an authentication failure; and
in the event of making such a detection, storing information to the effect that a fraud has been detected for a set comprising at least said public identity, said private identity, and said at least one address.

3. A fraud detection method according to claim 1 wherein said message includes a binary flag indicating whether or not said user accesses the IMS network via an NAT entity for address translation, and wherein said at least one address is constituted by:
a pair (public IP address, public port) when said access is not made via an NAT; or
a quadruplet (public IP address, public port, private IP address, private port) when said access is made via an NAT.

4. A fraud detection method according to claim 1 wherein, if said verification step process is not valid, the method includes a process of incrementing a first fault counter associated with said set.

5. A fraud detection method according to claim 2, wherein, when inconsistency in an authentication scheme or an authentication failure is detected, the method further includes incrementing a second fault counter associated with said set.

6. A fraud detection method according to claim 4 comprising updating a global fault counter associated with said public identity, said global fault counter summing all of said first and second counts associated with a set including said public identity.

7. A fraud detection method according to claim 4 wherein, when said first counter or said second counter or said global counter exceeds a first predetermined threshold, the method comprises sending a message to a fraud manager, said message including at least said public address.

8. A fraud detection method according to claim 4 wherein when said first counter or said second counter or said global counter exceeds a first predetermined threshold, the method includes sending a message to said I-CSCF entity, the message including the identifier of a fraud collector S-CSCF entity.

9. A fraud detection method according to claim 4 wherein when said first counter or said second counter or said global counter exceeds a second predetermined threshold, the method includes a step of sending a message to said I-CSCF entity, which message includes an error code.

10. An HSS server comprising:
circuitry which receives a message coming from an I-CSCF or an S-CSCF entity in an IMS network, said message mentioning a public identity, a private identity and at least one address of a user in the IMS network;
a processor configured to verify the validity and the consistency of said public and private identities;
memory which acts, if invalidity or inconsistency is found, to store information whereby a fraud has been detected for a set comprising at least said public identity, said private identity, and said at least one address.

11. An HSS server according to claim 10, further comprising:
a processor configured to detect, from said message inconsistency in an authentication scheme or an authentication failure or to detect an authentication failure; and
in the event of making such a detection, memory for storing information whereby a fraud has been detected for a set including at least said public identity, said private identity, and said at least one address.

12. A non-transitory computer readable medium having stored thereon a computer program including instructions for executing the fraud detection method according to claim 1 when said program is executed by an HSS server in an IMS network.

13. A non-transitory data medium that is non-removable, or partially or totally removable, that is readable by a computer, and that includes instructions of a computer program for executing the fraud detection method according to claim 1.
